(19) United States
(12) Patent Application Publication
(10) Pub. No.: US 2006/0090605 A1
(43) Pub. Date: May 4, 2006

(54) Hammer with mallet head and measuring handle

(75) Inventors: Kathleen Fisher, Lindenhurst, IL (US); Jeffrey A. DeBoer, Ann Arbor, MI (US); Michael Nellenbach, Clawson, MI (US)

Correspondence Address: CARLSON, GASKEY & OLDS, P.C., 400 WEST MAPLE ROAD, SUITE 350, BIRMINGHAM, MI, 48009, US

(73) Assignee: The Faucet Queens, Inc.

(21) Appl. No.: 10/980,065

(22) Filed: Nov. 3, 2004

(51) Int. Cl. B25D 1/02; B25D 1/00

(52) U.S. Cl. 81/25; 81/22

(57) ABSTRACT

A hammer equipped with a mallet attachment and a measuring scale. The mallet attachment includes a surface cap for covering the striking surface of the hammer such that the hammer is visible as a mallet which provides a resilient surface. A surface cap holder stores the surface cap when using the hammer. The measuring scale is located on a grip which surrounds a hammer shank. The hammer functions as both a hammer and a mallet.

### BACKGROUND OF THE INVENTION

The present invention relates to a hammer, and more particularly to a hammer equipped with a resilient mallet attachment and a measuring handle.

It is frequently convenient to have a tool which performs a multiple of functions. This is especially true when hanging a picture or other wall hangings. To complete this task, a hammer is typically required to drive fasteners. A tape measure may also be required to properly space the height and/or the distance between other wall hangings. To prevent damage to a wall or the wall hanging itself, a mallet may also be needed.

Multi-function hammers with some functionality to measure distances are known. Hammers of this type typically include a handle with an integrated tape measure. Hammers that include a handle with a measuring scale thereon are also known. Conventional multi-functional hammers are effective, but may be less that desirable from a convenience and integration standpoint.

Accordingly, it is desirable to provide a multi-purpose hammer which is functional and uncomplicated yet does not detract from the primary hammer function.

### SUMMARY OF THE INVENTION

The hammer of the present invention provides a tool with the functionality of a conventional hammer and a mallet.

The present invention includes a handle, a hammer head, and a mallet attachment. The handle includes a measuring scale thereon. The hammer head defines a striking surface, a central body and a set of claws. A mallet attachment is affixed to the central body of the hammer head between the striking surface and the claws.

The mallet attachment defines a surface cap, a surface cap holder and a surface cap attachment. The surface cap is placed over the striking surface when utilizing the hammer as a mallet. The surface cap holder stores the surface cap when utilizing the hammer conventionally. The surface cap attachment is connected to the surface cap and the surface cap holder and allows for the selective movement of the surface cap.

The hammer of the present invention provides an uncomplicated multi-purpose tool which measures distances and functions both as a conventional hammer and a mallet.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of the screwdriver in accordance with the present invention;

FIG. 2 is an illustrative view of the measuring handle of the present invention;

FIG. 3A is a perspective view of the mallet attachment of the present invention;

FIG. 3B is an illustrative view of the mallet attachment of the present invention mounted to the central body of a hammer head;

FIG. 4 is an illustrative view of the hammer of the present invention with the mallet attachment of the device in a mallet position; and

FIG. 5 is an illustrative view of the hammer of the present invention with the mallet attachment of the device in a stored position.

### DETAILED DESCRIPTION OF THE PREFERRED EMBODIMENT

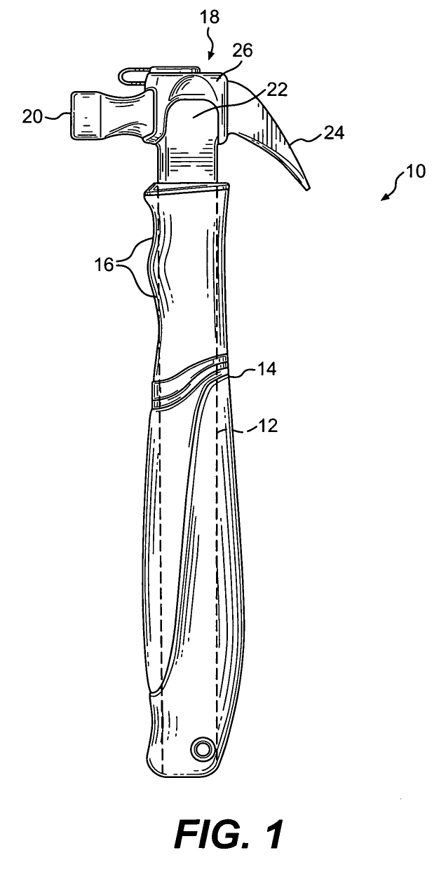

The hammer 10 of the present invention is illustrated in FIG. 1. A shaft 12 has the general form of an elongated rectangle. The shaft 12 is preferably manufactured of a metallic material. A grip 14 is formed around a portion of the shaft 12. The grip 14 is preferably manufactured of a resilient material such as rubber and/or plastic. Grip contours 16 are provided for improved gripping, aesthetic and ergonomic purposes.

A hammer head 18 is mounted to the shaft 12 on an end thereof. The hammer head 18 defines a striking surface 20, a central body 22 and a set of claws 24. The striking surface 20 is disposed on one side of the central body 22. The set of claws 24 is disposed on the opposite side of central body 22 from the striking surface 20. The striking surface 20 is generally a solid cylindrical member with a flat face for striking fasteners. The set of claws 24 function to remove fasteners. A mallet attachment 26 is connected to the central body 22 between the striking surface 20 and the set of claws 24.

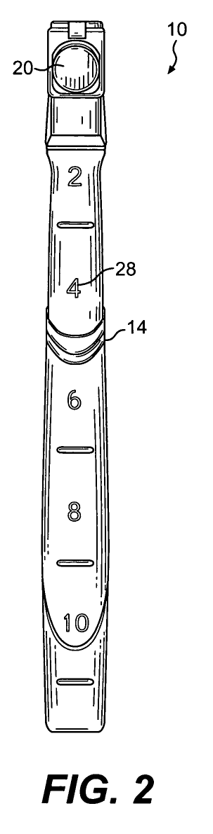

Referring to FIG. 2, the grip 14 includes a numeric scale 28 thereon. The numeric scale 28 can be of the English and/or Metric systems. Preferably, the numeric scale 28 is positioned on the striking surface 20 side of the hammer 10 on the grip 14, however other locations may also be utilized with the present invention. It is preferred that the numeric scale 28 be capable of measuring distances up to at least one foot.

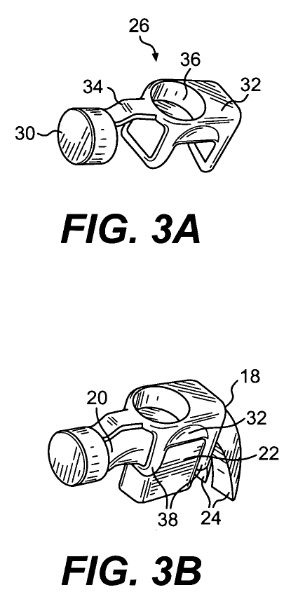

Referring to FIG. 3A, the mallet attachment 26 defines a surface cap 30, a surface cap holder 32 and a surface cap attachment 34. Preferably, the mallet attachment 26 is manufactured of a resilient material such as rubber and/or plastic. It should be understood that other materials may be utilized in the construction of the mallet attachment 26 of the present invention. The surface cap 30 is cylindrical and includes a hollow end that allows the surface cap 30 to fit over the striking surface 20. The surface cap holder 32 is rectangular shaped and includes a storage aperture 36 for storing the surface cap 30. The surface cap attachment 34 is connected to the surface cap 30 and the surface cap holder 32 and is flexible to allow for the selective movement of the surface cap 30 along the direction of the hammer head 18.

Referring to FIG. 3B, the surface cap holder 32 includes a pair of arms 38 for securely fastening the surface cap holder 32 to the central body 22 of the hammer head 18. The pair of arms 38 are offset on both sides of the central body 22 with one arm on the striking surface 20 end and the other arm on the end of the set of claws 24. The pair of arms 38 are each generally formed as a closed loop.

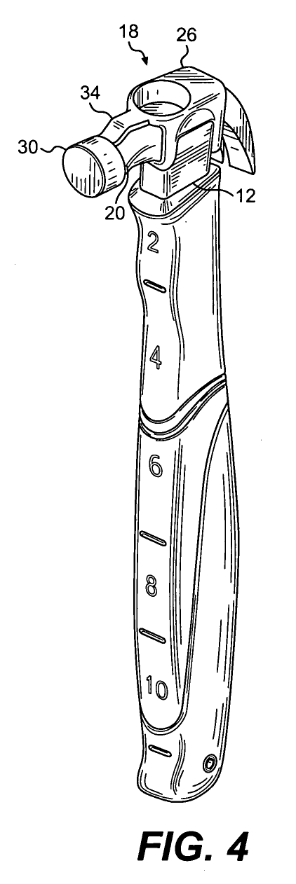

Referring to FIG. 4, the mallet attachment 26 is shown in the mallet position. Surface cap 30 selectively covers the striking surface 20. In this position, the surface cap attachment 34 is extended perpendicular to the shaft 12 and along the hammer head 18 in the direction of the striking surface 20.

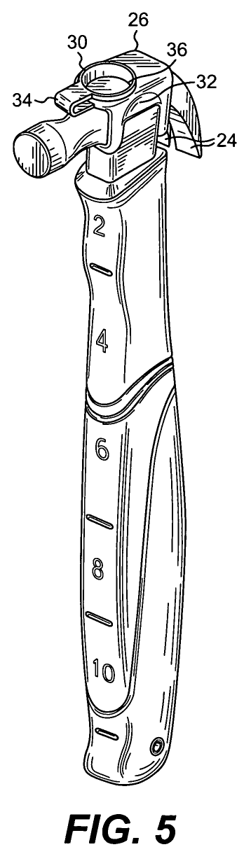

Referring to FIG. 5, the mallet attachment 26 is shown in the stored position. Surface cap 30 is selectively pressed into the storage aperture 36 of the surface cap holder 32. In this position, the surface cap attachment 34 extends in a U-shaped position in the direction of the set of claws 24.

That the foregoing description shall be interpreted as illustrative and not in a limiting sense is thus made apparent. A worker of ordinary skill in the art would recognize that certain modifications would come within the scope of this invention. For that reason, the following claims should be studied to determine the true scope and content of this invention.

1. A resilient mallet attachment for a hammer, comprising:
a surface cap;
a surface cap holder that defines a storage aperture for selectively receiving said surface cap; and
a flexible surface cap attachment connected to said surface cap and said surface cap holder.

2. The resilient mallet attachment for a hammer as recited in claim 1, wherein said surface cap holder and said flexible surface cap attachment are manufactured of a resilient material.

3. The resilient mallet attachment for a hammer as recited in claim 1, wherein said surface cap holder is mountable to a central body of a hammer head between a striking surface and a set of claws.

4. A resilient mallet attachment for a hammer, comprising:
a surface cap;
a surface cap holder wherein said surface cap holder includes at least one arm which extends around a hammer head; and
a flexible surface cap attachment connected to said surface cap and said surface cap holder.

5. The resilient mallet attachment for a hammer as recited in claim 4, wherein said surface cap holder includes a second arm which extends around said hammer head.

6. A hammer, comprising:
a handle;
a hammer head transversely mounted to said handle; and
a resilient mallet attachment mounted to said hammer head, said resilient mallet attachment defining a surface cap movable to selectively cover an entire striking surface of said hammer head.

7. The hammer as recited in claim 6, wherein said handle includes a measuring scale.

8. The hammer as recited in claim 6, wherein said hammer head defines a striking surface, a central body and a set of claws.

9. The hammer as recited in claim 8, wherein said resilient mallet attachment is mounted to said hammer head on said central body between said striking surface and said set of claws.

10. The hammer as recited in claim 6, wherein said resilient mallet attachment further comprises a surface cap holder and a flexible surface cap attachment connected to said surface cap and said surface cap holder.

11. The hammer as recited in claim 6, wherein said surface cap is movable to selectively store said surface cap at least partially within said surface cap holder.

12. A method of providing a mallet surface for a hammer, comprising the steps of:
(1) removing a surface cap from a surface cap holder; and
(2) pressing the surface cap over a striking surface to provide a mallet surface.

13. A method as recited in claim 12, wherein said step (1) further comprises the step of:
locating a first arm and a second arm of the surface cap holder around a hammer head.

14. A method as recited in claim 12, further comprising the step of:
(3) retaining the surface cap within a storage aperture of the surface cap holder to expose the striking surface.

15. The hammer as recited in claim 6, wherein said surface cap includes an annular portion and a planar face portion, said annular portion disposed about an outer periphery of said hammer head and said planar face portion disposed adjacent said annular portion to cover said entire striking surface of said hammer head.
